(19) United States
(12) Patent Application Publication
(10) Pub. No.: US 2011/0035128 A1
(43) Pub. Date: Feb. 10, 2011

(54) Electronic device for prevention and control of the street accidents risks attributable to the use of alcohol and/or their associated substances

(75) Inventors: Gianfranco Azzena, Ferrara (IT); Antonio La Gatta, Teolo (PD) (IT)

Correspondence Address: Themis Law, 7979 Ivanhoe Ave Ste 400, La Jolla, CA, 92037, US

(73) Assignee: ANGEL S.R.L., Napoli (IT)

(21) Appl. No.: 12/671,749

(22) PCT Filed: Jul. 31, 2008
(86) PCT No.: PCT/IB08/53077

§ 371 Date: May 13, 2010

(30) Foreign Application Priority Data
Aug. 3, 2007 (IT) PD2007U000075
Oct. 31, 2007 (IT) PD2007A00359

(51) Int. Cl. B60K 28/02; B60Q 1/00; G06G 7/70

(52) U.S. Cl. 701/70; 340/425.5; 701/101

(57) ABSTRACT

An electronic device related to the air composition in the car's compartment in general, purposed for the prevention and control of the street accident risks attributable to the use of alcohol and/or of associated substance taking one or more environment sensors (S1, . . . , Sn) of concentration observance or air qualification of one or more substance (X), a processing unit (UE) of the taken information from the sensors (S1, . . . , Sn) and in comparison with the limited value of the preset reference, and where the processing unit (UE) active, directly or indirectly, operations of actions to signal an alarm event as consequence to the positive comparison of at least one of the mentioned information.

The electronic device's observance and final data processing to the prevention and control of the street accidents risks attributable to the use of alcohol and their associated substances is as a principle scope to the diminution and the prevention of the street accidents determined from the alcohol and/or their associated substance consumption. Concerning the associated substances, it means to all substances that can alter the conduction capacity of a vehicle such as drug substances, medicine, etc.

The aforementioned problem is quite increasing in the deathly street accidents determined from the alcohol and/or associated substances.

Presently, the available system to measure the alcohol level that, has been used by drivers is breathalyzers.

These tools are essential subjects to 2 problems:
First problem is given to the fact that the subject must be volunteer to be tested by the tool.
Second is the lack of active feedback system from these tools.

The actual scope is to accomplish a system that able to point out the presence of alcohol and/or associated substances without direct willing come from the subject that allows an alteration to characteristic driving performances.

It is well known that the presence of alcohol in the blood can be traced with analyzing the gases residue in the subject's breath. Particularly, the alcohol molecule and of other associated substances, being volatile through alveolus giving a fact to their presence concentration in the expiratory.

For this purpose, the new electronic device's observance and final data processing to the prevention and control of the street accidents attributable to the use of alcohol and their associated substances bases its real function on the gases residue accumulation around the driver's adjacent.

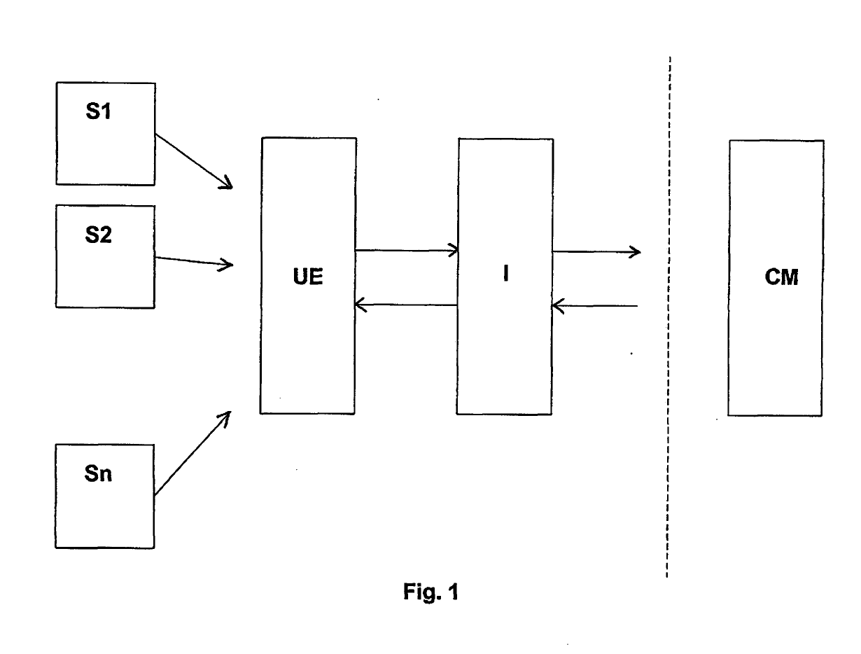

The enclosed table (FIG. 1) presents a scheme of brainwave operation as an illustrative subject but not limitative.

The new electronic device observance and final data processing to the prevention and control of the street accidents risks attributable to the use of alcohol and their associated substance includes:
One or more environment sensors (S1, . . . , Sn) able to perceive a very low concentration alcohol and/or their associated substance (X) molecular; these devices can be of the solid state type, e.g. MEMS or combustible isolation;
At least one processing unit (UE);
At least one control unit (I) direct interface to the central motor (CM) of automobile (car).

The new electronic device observance and final data processing to the prevention and control of the street consents to interfere based on the necessity with 3 different advanced functions:
TRIANGULATION
TEST OF COMBINED GAS
NEGATIVE LOGICAL SYSTEM

TRIANGULATION: the mentioned processing unit (UE) obtains cyclical mentioned sensors (S1 . . . SN), a proportional value to the alcohol and/or their associated substances' concentration, afterward defined as generic substance (X).

The obtained information speed is not critical and in each case, it must have a value not more than several minutes. To have a good processing algorithm, it is better to have an obtainable information speed in each 100 milliseconds.

Having more sensors (S1, . . . , Sn) grants the system other unique abilities in distinguishing substances sources (X) position.

This distinction ability is absolutely necessary as there might be more person inside the car but only the emission of substance (X) came from the driver has the interest to the specific problem.

The information came from the mentioned sensors (S1, . . . , Sn) are inserted in the mathematic pattern “A” dependent from the sensors arrangement (S1, . . . , Sn), from their sensitivity, from the cabin form, from the presence laminar flows.

The systematic solution of “A” equation, being theoretically practicable, it is actually an impossible fact to resolve; therefore, it will use a “reverse founding” method to define a numerical equivalent.

The operating sequence of Triangulation is described as following:
1. The sensors information (S1, . . . , Sn) and the internal sources of referred cabin arrange in normal function.
   In the moment that there is an indication of alcohol use from the subject, it will prepare the equivalent solution, for example using a manikin and come out from its mouth a concentration of alcohol defined as Xa (as a pattern). This (Xa) is a minimum value that being known in the law.
2. It sends a registered information from the sensors (S1, . . . , Sn) and at the same time, the source will emit the composed gas from the air together with the substance with the pattern (Xa).
3. The traces comes from variety sensors (S1, . . . , Sn), defines as S1r(t) . . . Snr(t) registered from the internal “n” record.

4. After a moment of “tf” the registration can be interrupted. The moment of “tf” is relative to the cabin dimension, to the substance (X), to the available sensors (S1, . . . , Sn). However, it is a value that cannot be more than 30 minutes, less than 180 seconds.

Therefore, the equation of “A” is a result of sequence mathematic operation in this exact order.

In the normal function, the sensors (S1, . . . , Sn) transfer continuously the information of the mentioned processing unit (UE).

It will insert a vector of S1(t) . . . Sn(t) inside the processing unit (UE). The equation “A” implied in the same processing unit (UE) following “n” borrowing convolution between S1(t) and S1r(t) and then between S2(t) and S2r(t) until Sn(t) and Snr(t), according to the equation (1) as following;

### Equation (1)

$$S 1 C ( n t ) = {\sum }_{k = 0}^{n} S 1 ( kt ) * S 1 r ( ( n - k ) t$$

At this point, there will be n vector available denominate S1c(t) . . . Snc(t). Afterwards, it will follow time integration to determine a normal area subordinate to the equation (2).

### Equation (2)

$$A 1 = {\sum }_{n = 0}^{n - max} S 1 C ( nt )$$

$$A 2 = {\sum }_{n = 0}^{n - max} S 2 C ( nt )$$

The result will be examined continuously with “n” coefficient (Ari) determined experimentally that typically can be posted around 30% of maximum possibility to the equation (2).

If a number is statistically significant (for example more than 50%) compare to the positive outcome, it can be considered as an alarm event that will trigger the sequent operation of the processing unit.

The possible intervention modes of the processing unit (UE) following an alarm event can be as following:
Maximum car speed diminution interfering directly on the central motor interface.
Acoustic and/or visual signal

COMBINATION OBSERVANCE OF MORE SUBSTANCES: In particular cases, it can be useful to monitor the presence and the concentration of gases, particularly alcohol and associated substances or gas and the oxygen concentration. For instance, a simultaneously high concentration of alcohol in the low oxygen concentration can be dangerous. Whenever it is necessary to monitor simultaneously more substances, the previous described system, the triangulation, can be used with different method that we would like to explain in the following.

The previous equation (1) and (2) is not a valid method approach but it is inserted as multiply constant of S1(t) . . . Sn(t) vector, a coefficient k1 . . . kn according to the following criteria;
Constant “kn” is more dangerous than the substances. It presume, for example, “kn=1” for the alcohol and to define that the danger of other substances “normal” according to the equation (3) based on the danger of alcohol taken.

$$Kn s = \frac{Other danger}{Alcohol danger} \qquad Equation ( 3 )$$

Constant “kn” is taken as negative signal if the substance to be controlled is a substance that triggers an alarm event when its concentration is low and not high (for example the oxygen)

It is only at the aforementioned example, we can say typically, but not necessarily use.

“kn=1” for the alcohol and “kn=−50” for the oxygen, please pay attention to the presence and position of less signal. Appropriate value can be experimentally deduced.

INTERVENTION SYSTEM: Particular attention is placed to the intervention system in the following alarm event test.

When the central motor (CM) has already all security systems attached to maintain the effectiveness of speed automatic mechanism, it is sufficient to send the aforementioned information of active alarm event and the maximum speed management must be conducted from the said processing unit (UE) inside your device.

An example of sequence algorithm that implements this function is as following:
Street Security System. This algorithm is written in Assembler for AVR micro control with CORE 8051.
SSS Algorithm
VAR:
Alarm_flag=1 if it is verified an alarm condition
Pos_acc=accelerator pedal position
Pos_max=pedal position correspond to the maximum acceleration
Speed=car's immediate speed
COST:
If Alarm_flag=1 AND Pos_acc<0.1 Pos_max AND Speed<50
THEN Speed max=50.

Otherwise, if the alarm event condition is verified, then the mentioned control unit (I), interfacing the said central electronic motor (CM), raises the accelerator pedal position according to the reported position of correspondent pedal position at maximum speed and car's gear to determine a limited value and if the mentioned position of the accelerator pedal is less than 10% of the pedal position that correspondence to the maximum acceleration and if the car's gear for the speed is less than the mentioned limited value, then the control unit (I) communicates to the electronic central motor to give a speed limit to the mentioned value.

Furthermore, it is foreseen that the mentioned electronic device is bounded to be a car's transferable mode, permanently connected to the central electronic motor (CM) and activate the car's ignition system. The motor ignition is conditioned to the relevant and verified information as described previously.

Therefore, with the reference to the previous description and to the enclosed table, they experience the following demand.

1. Electronic device observation and relevant information processing to the air composition inside the car's compartment in general, purposed for the prevention and the control of street accidents risks attributable to the use of alcohol and/or their associated substances characterized by the understanding fact that:
One or more environment sensors (S1, . . . , Sn) of the relevant concentration or subject in the air has one or more substances (X);
At least one processing unit (UE) of the obtained information come from the sensors (S1, . . . , Sn) is comparable with the limited value of the pre-arranged reference,
and when the mentioned processing unit (UE) is active, directly or indirectly, operates the alarm event signal in consequence to the positive comparison to at least one of the mentioned information.

2. Information processing of electronic device for the car in general, as indicated in demand 1, characterized by the fact of being understand at least one control unit or interface (I) and communicate with the mentioned processing unit (UE) and interface it to the central electronic motor (CM) of the car, to modify the performance of car's characteristic just in case of alarm event.

3. Information processing of electronic device for the car in general, as indicated in demand 2, characterized by the fact that the mentioned control unit (I) is interfaced to the central electronic motor (CM) of the car, to prevent the car's motor ignition.

4. Information processing of electronic device for the car in general, as indicated in demand 2, characterized by the fact that the mentioned control unit (I) is interfaced to the central electronic motor of the car to give a limit to the car's speed when it is in motion or in the beginning of motor ignition.

5. Information processing of electronic device for the car in general, as indicated in demand 1, characterized by the fact of being understand at least one control unit (I), communicating with the processing unit (UE) and interface it to the central electronic (CM) of the car to activate acoustic and/or light signal just in case of alarm event.

6. Information processing of electronic device for the car in general, as indicated in demand 1, 2, 3, 4, 5, characterized by the fact that the mentioned substance (X) is alcohol or ethanol or drug or associated substances.

7. Information processing of electronic device for the car in general, as indicated in demand 1, 2, 3, 4, 5, characterized by the fact that the mentioned substance (X) is oxygen.

8. Information processing of electronic device for the car in general, as indicated in demand 1, 2, 3, 4, 5, characterized by the fact that the mentioned substance (X) is a drug substance and/or a medical substance and/or other substances in acceptable dosage which allows the driver to run a car.

9. Information processing of electronic device for the car in general, as indicated in previous demand, characterized by the fact that the mentioned sensors (S1, . . . , Sn) are of the solid state type, for instance MEMS, or a combustible isolation.

10. Information processing of electronic device for the car in general, as indicated in previous demand, characterized by the fact that the mentioned sensors (S1, . . . , Sn) takes the mentioned information in the interval time less than 180 seconds.

11. Information processing of electronic device for the car in general, as indicated in previous demand, characterized by the fact of understanding two or more mentioned sensors (S1, . . . , Sn) distributing in the car's compartments surrounding the driver's place, in a certain distance and other determined positions in regard to the driver's place.

12. Information processing of electronic device for the car in general, as indicated in previous demand, characterized by the fact that all or some of the mentioned sensors (S1, . . . , Sn) are adjusted to the certain substance (X) by changing it in a certain interval time (tf), by a predefined value and well known concentration or subject (Xa) of the mentioned substance (X) injected in the compartment, producing n vector of the reference values (S1r(t), . . . , Snr(t)), where t is varies from 0 to tf.

13. Information processing of electronic device for the car in general, as indicated in demand 12, characterized by the fact that the mentioned time interval (tf) is proportional to car's compartment size, according to the substance(s) being observed and to the available sensor's space.

14. Information processing of electronic device for the car in general, as indicated in demand 12, 13, characterized by the fact that mentioned time interval (tf) is less than 180 seconds.

15. Information processing of electronic device for the car in general, as indicated in demand 12, 13, 14, characterized by the fact that:
in normal function, the said sensors (S1, . . . , Sn) observe the concentration value of the certain substance (X), producing a plural vector of high value (S1(t), . . . , Sn(t));
the said processing unit (UE) gather these high value vectors (S1(t), . . . , Sn(t)) and reference value vector (S1r(t), . . . , Snr(t)) and follows n borrowing convolution between each previous value (Si(t)) and the correspondent reference value (Sir(t)), producing n vector of values (S1C(t), . . . , SnC(t)), where t vary from 0 to tf and where
$$SiC ( nt ) = {\sum }_{k = 0}^{n} Si ( kt ) * Sir ( ( n - k ) t )$$
with i that vary from 1 to n;
the processing unit (UE) follows a time integration of each value of SiC(t), producing n value (Ai), one for each sensor Si, where
$$Ai = {\sum }_{n = 0}^{n - max} SiC ( nt )$$
with i that vary from 1 to n;
the processing unit (UE) compare to the n value (Ai) respectively to n value (Ari) of reference definite experiment,
and where the alarm event or of the immediate blocking system or deferred motor verifies in case of the comparison resulted positive for a determinate percentage of mentioned values (Ai).

16. Information processing of electronic device for the car in general, as indicated in demand 15, characterized by the fact that each of the reference values (Ari) is equal with 30% of possible maximum value of the relative value (Ai).

17. Information processing of electronic device for the car in general, as indicated in demand 15, 16, characterized by the fact that the alarm event or of immediate blocking system or deferred motor verifies in case of comparison resulted positive for a bigger percentage or as same as 50% of the values (Ai).

18. Information processing of electronic device for the car in general, as indicated in demand 17, characterized from the fact that the comparison is positive if:
Ai<Ari, for substance (X) in which the concentration must be superiorly limited, like ethanol or associated substance;
Ai>Ari, for substance (X) in which the concentration must be inferiorly limited, like oxygen.

19. Information processing of electronic device for the car in general, as indicated previously, characterized by the fact that the processing unit (UE) multiply each of the raised value of the vector (S1(t), . . . , Sn(t)) for a constant value (Kn), where;
Kn=1, for alcohol or ethanol;
Absolute value of Kn>1, for substance more dangerous than alcohol;
Kn<0, for substance in which the concentration must be inferiorly limited.

20. Information processing of electronic device for the car in general, as indicated in demand 4, characterized by the fact that if the condition of alarm event is verified, then the control unit (I), interfacing the central electronic motor (CM), take over the accelerator position according to the present maximum acceleration position and the speed gear according to the determinate limit value, and if the raised accelerator pedal is inferior than 10% to the correspondent accelerator pedal and if the speed gear of the car is inferior than the limited value, then the control unit (I) communicates to the central electronic motor (CM) to give a limit to the speed gear for the maximum limit value.

21. Information processing of electronic device for the car in general, as indicated in demand 20, characterized by the fact that the limit value of the speed gear is at maximum 50 km/h.

22. Information processing of electronic device for the car in general, as indicated previously, characterized by the fact to be bound in stay mode, permanently connected to the central electronic (CM) and activate the ignition control and where the motor ignition is conditioned to the take over and from the verification of the information and of the conditions to the previous demand.
